(19) United States
(12) Patent Application Publication
(10) Pub. No.: US 2005/0258007 A1
(43) Pub. Date: Nov. 24, 2005

(54) Three-wheeled braking wheelbarrow

(75) Inventor: Barry R. Albert, Dillsburg, PA (US)

Correspondence Address: William F. Lang, IV;Eckert Seamans Cherin & Mellott, LLC, 44th Floor, 600 Grant Street, Pittsburgh, PA, 15219, US

(73) Assignee: Ames True Temper, Inc., Camp Hill, PA (US)

(21) Appl. No.: 11/136,224

(22) Filed: May 24, 2005

Related U.S. Application Data
(60) Provisional application No. 60/573,887, filed on May 24, 2004.

(51) Int. Cl. B62B 3/00; B62B 1/00

(52) U.S. Cl. 188/2 D; 280/47.34; 280/62

(57) ABSTRACT

A wheelbarrow includes three wheels so that it may be pushed without being lifted, thereby minimizing the potential for operator injuries due to lifting the wheelbarrow. A braking mechanism including a lever having one end for engaging a user's hand or foot, and another end for engaging a sprocket secured to one of the wheels, may be used to resist movement of the wheelbarrow when such movement is not desired.

### CROSS-REFERENCE TO RELATED APPLICATION

This application claims the benefit of U.S. Provisional Patent Application No. 60/573,887, filed May 24, 2004, entitled “Three-Wheeled Braking Wheelbarrow.”

### BACKGROUND OF THE INVENTION

1. Field of the Invention

The present invention relates to wheelbarrows. More specifically, the present invention provides a wheelbarrow having three wheels, and a brake for at least one of the three wheels.

2. Description of the Related Art

Conventional wheelbarrows typically include a single wheel and a pair of legs. When the legs are resting on the ground, the legs resist movement of the wheelbarrow. To move the wheelbarrow, the legs must be lifted off the ground throughout the entire movement. This constant lifting causes operator fatigue and increases the risk of injury to the operator. Additionally, the single wheel of such a wheelbarrow can increase the difficulty in moving the wheelbarrow if the load therein is off balance.

The presently available three-wheeled wheelbarrow is presently offered by Prestar Manufacturing, and is disclosed in U.S. Patent Application No. US 2004/0041361 A1, published on Mar. 4, 2004. One embodiment of this wheelbarrow includes a pair of plates having J-shaped channels mounted on each leg. An axle having a wheel at each end passes through the J-shaped channels. Placing the axle in the shorter portion of the J-shaped channel allows the wheelbarrow to roll along three wheels. Placing the axle in the longer portion of the J-shaped channel permits the legs of the wheelbarrow to touch the ground, thereby resisting movement of the wheelbarrow. This wheelbarrow still requires some lifting prior to moving the wheelbarrow, and then to prevent movement of the wheelbarrow after it is pushed to the desired location.

Accordingly, there is a need for a wheelbarrow having at least three wheels so that it does not to be lifted in order to be pushed. Additionally, there is a need for a wheelbarrow having a braking mechanism that does not require lifting the wheelbarrow.

### SUMMARY OF THE INVENTION

The present invention provides a wheelbarrow or other wheeled cargo-carrying cart having three wheels, and having a brake mechanism for resisting movement of the wheelbarrow.

For the purpose of this description, a wheeled cargo-carrying cart is defined as any wheeled implement having a platform, bucket, bed, seat, or any other cargo-holding means secured to a frame, having a plurality of wheels secured thereto, and being structured to be manually pushed or pulled from one location to another. A wheelbarrow is a preferred embodiment of a wheeled cargo-carrying cart with which the present invention may be used, and the invention is described and illustrated herein based on this example. In other embodiments, the wheeled cargo-carrying cart may be structured to transport human or other living cargo, as in the example of a wheelchair.

A wheelbarrow of the present invention includes containers secured within a frame. The frame includes a front wheel and a pair of rear legs depending downward therefrom, and a pair of handles extending rearward therefrom. A pushbar extends upward from the handles.

An axle is rotatably secured to the legs, with a wheel disposed on each end of the axle. At least one of the wheels includes a brake mechanism for resisting movement of the wheelbarrow. The brake includes a lever pivotally secured to the frame, and having one end structured to engage one of a plurality of cutouts within a sprocket that is secured to at least one of the wheels. The other end of the lever is structured to be moved towards and away from the sprocket by either the operator's hand or foot. The handle also includes means for securing the handle in either a braking position or a released position, with one preferred means being a nylock nut as part of the handle's pivot, for providing friction to the pivoting of the handle.

The present invention therefore provides a wheelbarrow having three wheels, that may be pushed from one location to another without lifting it. The present invention further provides a wheelbarrow having a braking means for resisting movement of the wheelbarrow when such movement is not desired, and which does not require lifting of the wheelbarrow.

Accordingly, it is an object of the present invention to provide a wheelbarrow having at least three wheels, so that it may be pushed without being lifted.

It is another object of the invention to provide a wheelbarrow having a braking mechanism to resist movement of the wheelbarrow when such movement is not desired.

It is a further object of the invention to provide a wheelbarrow having a braking mechanism that may be configured for operation by the user's hand or foot.

These and other objects of the invention will become more apparent through the following description and drawings.

### BRIEF DESCRIPTION OF THE DRAWINGS

FIG. 1 is a side perspective view of a wheelbarrow according to the present invention.

FIG. 2 is a rear perspective view of the legs and wheels of a wheelbarrow according to the present invention.

FIG. 3 is a perspective side view of a braking mechanism for a wheelbarrow according to the present invention.

FIG. 4 is a side perspective view of a braking mechanism for a wheelbarrow according to the present invention.

FIG. 5 is a side view of a braking mechanism for a wheelbarrow according to the present invention.

FIG. 6 is a side perspective view of the partially disassembled components of a braking mechanism for a wheelbarrow according to the present invention.

FIG. 7 is a side perspective of a wheel for a wheelbarrow having a braking mechanism of the present invention.

FIG. 8 is a rear perspective view of an alternative embodiment of a braking mechanism for a wheelbarrow according to the present invention.

Like reference characters denote like features throughout the drawings.

### DETAILED DESCRIPTION OF THE PREFERRED EMBODIMENTS

The present invention provides a wheelbarrow having at least three wheels, and having a braking means for resisting movement of at least one of the wheels when desired.

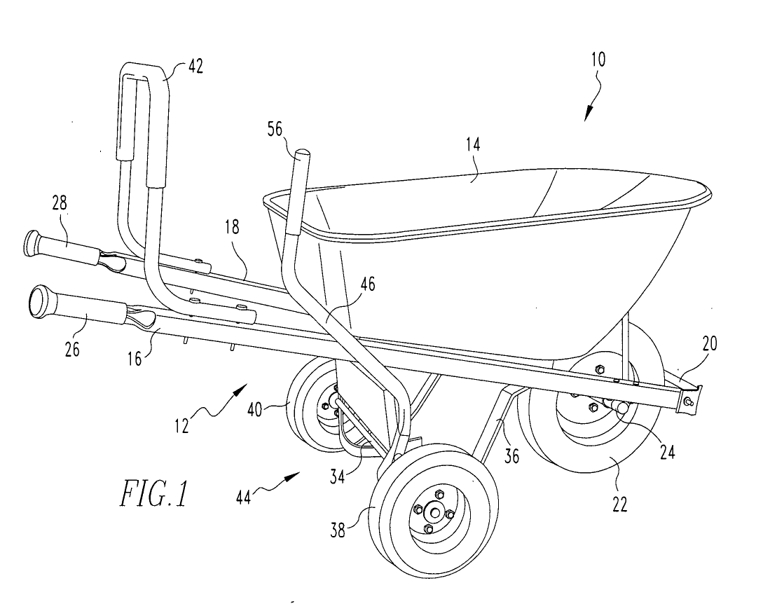

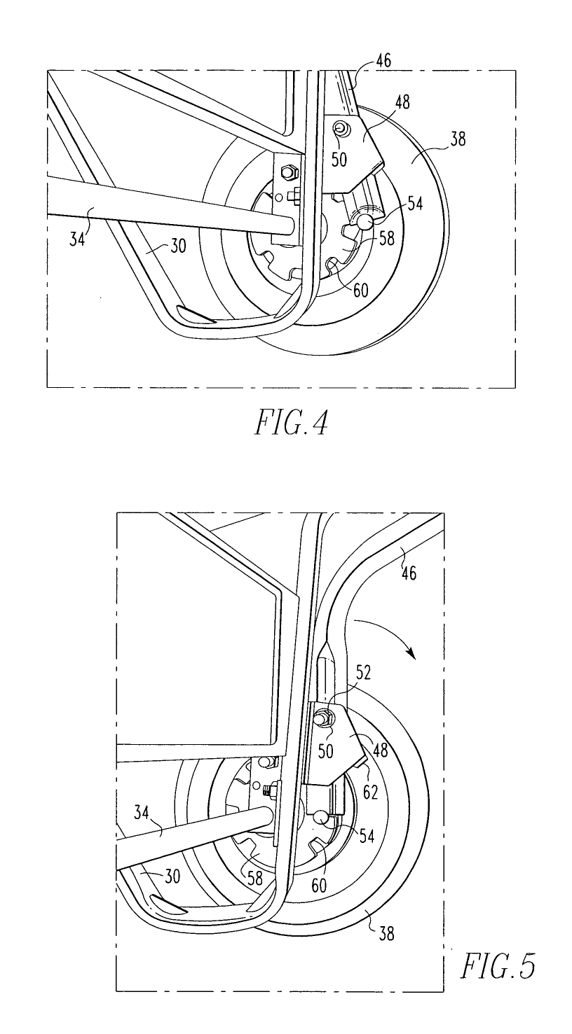

Referring to FIGS. 1-5, the wheelbarrow 10 includes a frame 12 supporting a bucket or container 14. In the illustrated embodiments, the frame 12 includes a pair of elongated beams 16, 18 that may be secured together by the front cross beam 20. A front wheel 22 rotates about an axis 24 secured to a forward portion of the beams 16, 18. The opposite ends of the elongated beams 16, 18 terminate in the handles 26, 28. A pair of legs 30, 32 depend downward from the elongated beams 16, 18. An axle 34 is pivotally secured to the legs 30, 32, in the illustrated example by the axle bracket 36. A wheel 38, 40 is secured to each end of the axle 34. In some preferred embodiments, the wheels 38, 40 may rotate independently with respect to each other and with the axle 34. The bucket 14 is disposed above the frame 12, and has a center of gravity disposed within the triangle formed by the wheels 22, 38, 40. A pushbar 42 extends upward from the elongated beam 16, 18, adjacent to the handles 26, 28.

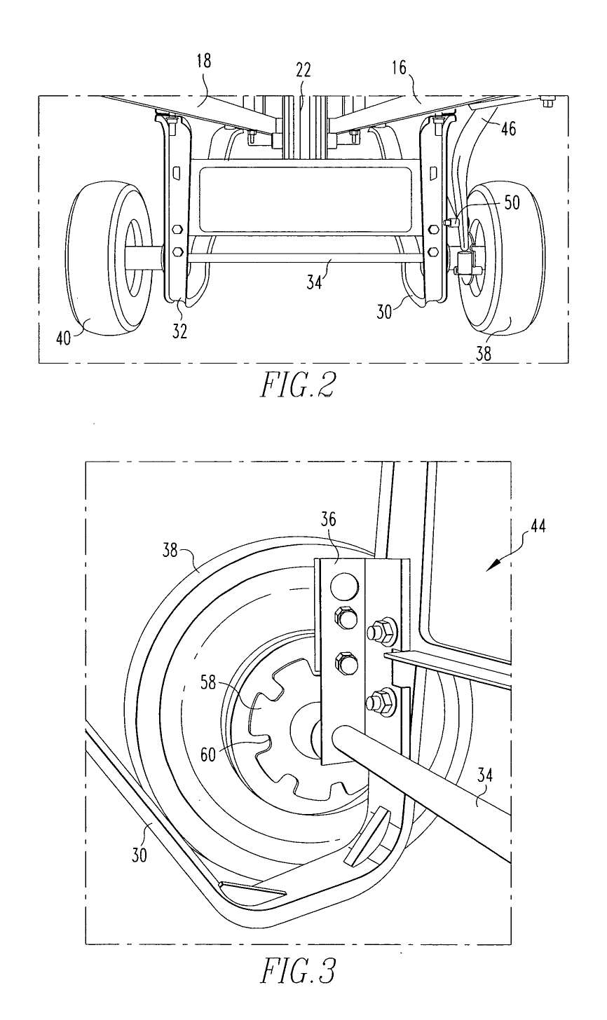

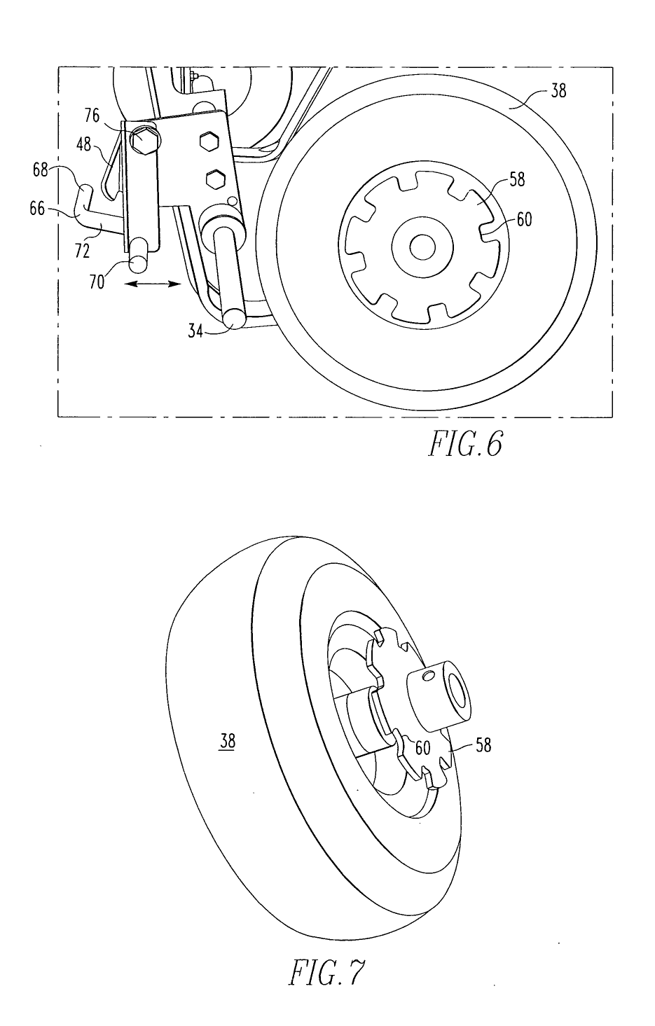

Referring to FIGS. 2-6, the wheelbarrow 10 includes a brake that may be selectively engaged by the user. The brake 44 includes a brake lever 46 pivotally secured to the frame 12. In a preferred embodiment, the brake lever 46 is pivotally secured to a brake lever bracket 48, which is itself secure to the leg 30. In the illustrated example, the pivot 50 between the brake lever 46 and brake lever bracket 48 is formed by a brake passing through a bolt having a nylock nut 52 secured to one end. The tension of the nylock nut 52 may be adjusted to provide a desired level of friction, so that undesired movement of the brake lever 46 is resisted, but the friction may be overcome by the operator when the brake lever 46 must be moved. A pin 54 extends outward from the lower end of the brake lever 46, towards the wheel 38. A handle 56 is located at the upper end of the brake lever 46.

The wheel 38 includes a sprocket 58 defining a plurality of notches 60, with each notch being dimensioned and configured to receive the pin 54. When the brake lever 46 is pulled away from the bucket 14, the pin 54 is moved into one of the notches 60, thereby resisting movement of the wheel 38, and securing the wheelbarrow 10 in place. Moving the brake lever 46 towards the bucket 14 removes the pin 54 from the notch 60, thereby permitting movement of the wheel 38 and the wheelbarrow 10. A stop 62 depending outward from the brake lever bracket 48 resists undesired movement of the brake lever 46 substantially farther than that necessary to disengage the pin 54 from the notch 60.

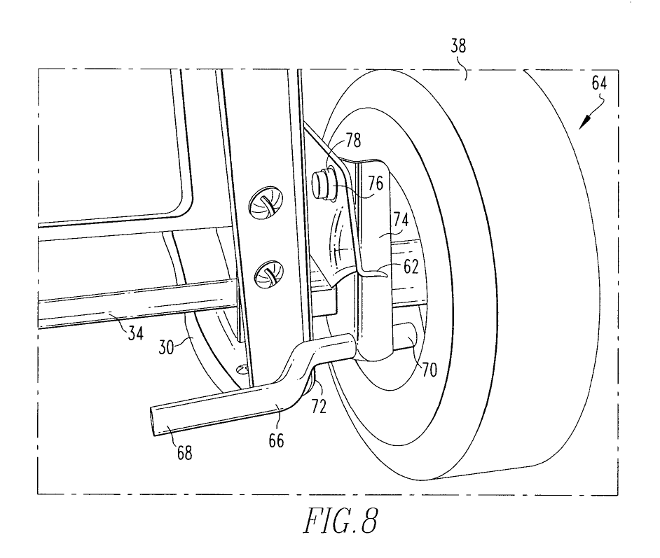

Referring to FIGS. 7-8, another embodiment of the brake 64 is illustrated. The brake 64 includes a rod 66 having substantially parallel first and second ends 68, 70, and a central section 72 that is angled with respect to the first and second ends 68, 70. The second end 70 is connected to the lower end of a bracket 74, which is pivotally connected to the brake lever bracket 48 by the pivot 76 at its upper end. The pivot 76 may be formed from a bolt secured to a nylock nut 78, which is tightened to provide sufficient friction to resist undesired movement of the bracket 74 and rod 66, without providing enough friction to provide undue resistance to a user applying or disengaging the brake 64. When the rod 66 is raised so that the bracket 74 engages the stop 62, the wheel 38 is free to rotate. Pushing down on the first end 68 of the rod 66 pivots the rod 66 and bracket 74 so that the second end 70 engages a notch 60 within the sprocket 58, thereby resisting movement of the wheel 38.

The present invention therefore provides a brake for a three-wheeled wheelbarrow that may, depending upon the embodiment selected, by operated by the user's hand or foot. The brake resists movement of at least one wheel when engaged, and permits the wheelbarrow to be pushed when disengaged. The present invention therefore minimizes or eliminates the need to lift the wheelbarrow 10 during use, because the wheelbarrow may be pushed to a desired location and then secured at that location through manipulation of the brake instead of by lifting the wheelbarrow. Fatigue and injuries to the user are thereby made less likely to occur.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

1. A brake for a wheeled cargo-carrying cart, the wheeled cargo-carrying cart having a frame with a plurality of wheels rotatably secured thereto, the brake comprising:
a sprocket secured to one of the plurality of wheels, the sprocket defining a plurality of notches about its periphery; and
a lever movably secured to the frame, the lever having a pair of ends, one of the ends being structured to engage a notch defined within the sprocket, the lever being structured to move from a braking position wherein the lever engages the sprocket, and a movement position wherein the lever is separated from the sprocket.

2. The brake according to claim 1, wherein the lever is pivotally secured to the frame.

3. The brake according to claim 2, wherein the lever is secured to the frame by a bolt having a nylock nut secured at one end.

4. The brake according to claim 1, wherein the opposite end of the lever includes a handle.

5. The brake according to claim 1, wherein the opposite end of the lever is structured to be moved by a user's foot.

6. A wheeled cargo-carrying cart, comprising:
a frame;
a plurality of wheels rotatably secured to the frame; and
a brake, comprising:
a sprocket secured to one of the plurality of wheels, the sprocket defining a plurality of notches about its periphery; and
a lever movably secured to the frame, the lever having a pair of ends, one of the ends being structured to engage a notch defined within the sprocket, the lever being structured to move from a braking position wherein the lever engages the sprocket, and a movement position wherein the lever is separated from the sprocket.

7. The wheeled cargo-carrying cart according to claim 6, wherein the lever is pivotally secured to the frame.

8. The wheeled cargo-carrying cart according to claim 7, wherein the lever is secured to the frame by a bolt having a nylock nut secured at one end.

9. The wheeled cargo-carrying cart according to claim 6, wherein the opposite end of the lever includes a handle.

10. The wheeled cargo-carrying cart according to claim 6, wherein the opposite end of the lever is structured to be moved by a user's foot.
